(19) United States
(12) Patent Application Publication
(10) Pub. No.: US 2023/0323256 A1
(43) Pub. Date: Oct. 12, 2023

(54) PROCESS FOR MAKING A PACKAGED LAUNDRY DETERGENT POWDER

(71) Applicant: The Procter & Gamble Company, Cincinnati, OH (US)

(72) Inventors: Andrew Richard CONSTABLE, Whitley Bay (GB); Hossam Hassan TANTAWY, Morpeth (GB); Alan Thomas BROOKER, Newcastle upon Tyne (GB); Benjamin Mark HADDRELL, Newcastle upon Tyne (GB); Lindsey HEATHCOTE, Northumberland (GB); Kerry Louise SWABEY, Newcastle upon Tyne (GB)

(21) Appl. No.: 18/210,243

(22) Filed: Jun. 15, 2023

Related U.S. Application Data
(63) Continuation of application No. PCT/US2022/034695, filed on Jun. 23, 2022.

(30) Foreign Application Priority Data
Jun. 25, 2021 (EP) 21181895.0

(51) Int. Cl. C11D 17/06; C11D 11/00; C11D 1/22; C11D 3/20; C11D 3/50; C11D 3/42

(52) U.S. Cl. CPC C11D 17/06; C11D 11/0017; C11D 3/42; C11D 3/2086; C11D 3/50; C11D 1/22

(57) ABSTRACT

A process for making a packaged laundry detergent powder.

### FIELD OF THE INVENTION

The present invention relates to a process for making a packaged laundry detergent powder. The process enables a packaged laundry detergent powder to be produced that comprises the required high level of citric acid, has the very low pH profile required to deliver the hygiene, freshness and fabric care benefits, whilst also has good powder flowability and good storage stability profiles.

### BACKGROUND OF THE INVENTION

Laundry detergent powder compositions are typically formulated at a relatively high alkaline pH, usually around pH 10.5. A common formulation approach is to achieve this pH profile through the incorporation of a stoichiometric excess of sodium carbonate. Whilst this level of alkalinity provides excellent cleaning performance, there is a recent consumer trend for desiring less cleaning performance and more fabric care performance from their laundry detergent products.

One formulation strategy to address this consumer trend is to lower the pH of the laundry detergent powder. Laundry powder formulation strategies, wherein the laundry powder has a pH profile of 6.0-9.0 and 6.0 to 8.0, have been explored more recently, and the impact on the product's performance by the incorporation of specific detergent ingredients has been studied. These low pH laundry detergent products do provide a different cleaning/care performance that is skewed more towards fabric care, with the cleaning performance skews being addressed and mitigated by selective detergent ingredients.

However, there is an even more recent move towards laundry detergent powders having an even lower pH profile. These laundry detergent powders have a pH profile of from 2.0 to 4.0. These laundry detergent powder products provide good hygiene, freshness as well as care benefits.

A common way to provide the pH profile of these laundry powders is to formulate high levels of citric acid into the product. Such an approach is a very efficient and commercially viable way to achieve the desired pH profile.

However, incorporating such a high level of citric acid into the laundry powder is not straightforward and poses some process challenges. The most significant being the poor flowability of the laundry powder and the poor stability profile of the laundry detergent powder.

The present invention provides a process for preparing these very low pH laundry detergent powders that comprise high levels of citric acid. The process of the present invention provides a packaged laundry detergent powder, and controls the process conditions, especially the relative humidity, of a number of key process steps during the production of the packaged laundry detergent powder. More specifically, when the citric acid is contacted to the detergent base powder, and when the laundry detergent powder is transferred to storage vessel and during the packing of the laundry detergent powder.

In this manner, a packaged laundry detergent powder can be produced that comprises the required high level of citric acid, has the very low pH profile required to deliver the hygiene, freshness and fabric care benefits, and also has good powder flowability and good storage stability profiles.

### SUMMARY OF THE INVENTION

The present invention provides a process for making a packaged laundry detergent powder, wherein the process comprises the steps of: (a) obtaining a laundry detergent base powder comprising detersive surfactant; (b) contacting citric acid particles to a detergent base powder in a mixer to form a laundry detergent powder, wherein the citric acid particles have a weight average particle size of from 100 μm to less than 450 μm, and wherein at least 99 wt % of the citric acid particles have a particle size of from 100 μm to less than 650 μm, wherein the laundry detergent powder, upon dilution in deionized water at 20° C. to a concentration of 1 g/l has a pH in the range of from 2.0 to 4.0, and wherein the laundry detergent powder comprises: (i) from 1 wt % to 60 wt % detersive surfactant; and (ii) from 40 wt % to 80 wt % citric acid; (c) transferring the laundry detergent powder from the mixer to a storage vessel; and (d) transferring the laundry detergent powder from the storage vessel to a package to form a packaged laundry detergent powder, wherein steps (b), (c) and (d) are carried out at an equilibrium relative humidity (eRH) of 45% or less.

### DETAILED DESCRIPTION OF THE INVENTION

### Process for Making a Packaged Laundry Detergent Powder

The process for making a packaged laundry detergent powder comprises the steps of: (a) obtaining a laundry detergent base powder comprising detersive surfactant; (b) contacting citric acid particles to a detergent base powder in a mixer to form a laundry detergent powder, wherein the citric acid particles have a weight average particle size of from 100 μm to less than 450 μm, and wherein at least 99 wt % of the citric acid particles have a particle size of from 100 μm to less than 650 μm, wherein the laundry detergent powder, upon dilution in deionized water at 20° C. to a concentration of 1 g/l has a pH in the range of from 2.0 to 4.0, and wherein the laundry detergent powder comprises: (i) from 1 wt % to 60 wt % detersive surfactant; and (ii) from 40 wt % to 80 wt % citric acid; (c) transferring the laundry detergent powder from the mixer to a storage vessel; and (d) transferring the laundry detergent powder from the storage vessel to a package to form a packaged laundry detergent powder, wherein steps (b), (c) and (d) are carried out at an equilibrium relative humidity (eRH) of 45% or less, preferably from 30% or less.

Typically, the eRH of step (b) is determined by measuring the eRH of the laundry detergent powder produced during step (b).

Typically, the eRH of step (c) is determined by measuring the ERH of the laundry detergent powder in the storage vessel (by taking a sample from the storage vessel).

Typically, the eRH of step (d) is determined by measuring the ERH of the laundry detergent powder in the sachet (by opening a sachet).

Typically, the eRH of the sample is measured as soon as reasonably possibly.

### Step (a) Obtaining a Laundry Detergent Base Powder

Step (a) obtains a laundry detergent base powder comprising detersive surfactant.

The laundry detergent base powder can be prepared by any suitable method. For example: spray-drying, agglomeration, extrusion and any combination thereof.

Suitable spray-drying, agglomeration and other powder processing techniques that are suitable for step (a) are described in more detail below (section titled: Process for making the solid composition).

### Step (b) Forming a Laundry Detergent Powder

Step (b) contacts citric acid particles to the detergent base powder in a mixer to form a laundry detergent powder.

Other particles may also be contacted with the laundry detergent base powder and the citric acid particles. Other suitable particles include: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof. However, due to the very low pH (acidic) requirement of the laundry detergent powder, the addition of alkaline ingredients such as carbonate particles and silicate particles during step (b) is preferably minimized or even avoided.

### Step (c) Transferring the Laundry Detergent Powder to a Storage Vessel

Step (c) transfers the laundry detergent powder from the mixer to a storage vessel.

The laundry powder is typically gravity-fed or belt-fed into a buggy (usually approx. 2mT) or a big bin, or big bag (usually approx. 1mT).

### Step (d) Forming a Packaged Laundry Detergent Powder

Step (d) transfers the laundry detergent powder from the storage vessel to a package to form a packaged laundry detergent powder.

Any suitable package can be used, such as a box, carton, bag or sachet. The package can be designed for single use or it can be designed for multiple use.

Typically during step (d), laundry powder is passed through a sifter to remove any lumps and then gravity fed into hopper whereby it is fed into suitable packs via gravimetric or volumetric (Auger or similar). Typically, the laundry powder is dosed into pack sizes of less than kg.

### Suitable Packs May be Individual or Dual Sachets.

### Citric Acid Particles

The citric acid particles have a weight average particle size of from 100 μm to less than 450 μm.

At least 99 wt % of the citric acid particles have a particle size of from 100 μm to less than 650 μm, or from 100 μm to less than 600 μm, or from 100 μm to less than 550 μm

Suitable citric acid particles can be supplied by Jungbunzlauer and/or Citrique Belge.

Suitable citric acid particles can be crystalline or anhydrous.

The citric acid particles may also be coated. Suitable coating includes monosodium citrate. A suitable coated citric acid particle is Citrocoat,(Jungbunzlauer). Typically, coated citric acid particles comprise from 60 wt % to 99.5 wt % citric acid core and from 0.5 wt % to 40 wt % coating, such as monosodium citrate.

### Laundry Detergent Base Powder

The laundry detergent base powder comprises detersive surfactant, preferably anionic detersive surfactant, more preferably C₁₁₋₁₃ linear alkyl benzene sulphonate.

Typically, the laundry detergent base powder is in the form of spray-dried base detergent particles and/or agglomerated base detergent particles and/or extruded base detergent particles. These base particles are then typically contacted with other particles, in addition to the citric acid particles, to form the laundry detergent powder.

### Laundry Detergent Powder

The laundry detergent powder comprises: (i) from 1 wt % to 60 wt % detersive surfactant; and (ii) from 40 wt % to 80 wt %, preferably from 50 wt % to 60 wt % citric acid.

The laundry detergent powder, upon dilution in deionized water at 20° C. to a concentration of 1 g/l has a pH in the range of from 2.0 to 4.0, preferably from 2.5 to below 3.0.

### The Laundry Detergent Powder Preferably Comprises:

(i) from 0.0001 wt % to 2.5 wt % perfume;
(ii) from 0.1 wt % to 6.0 wt % polymer;
(iii) from 0.0001 wt % to 3.0 wt % hueing agent; and
(iv) from 1 wt % to 58 wt % filler.

### A Suitable Laundry Detergent Powder is Illustrated Below.

| Ingredient | Range (wt %) |
|---|---|
| Citric acid | 40-80 |
| Chelant | 0-2 |
| Polymer | 0-4 |
| Anionic surfactant | 1-60 |
| Non-Ionic surfactant | 0-2.5 |
| Perfume | 0-2.5 |
| Hue dye particles | 0-1.5 |
| Process aid/structuring/ | 0-58 |
| filler | |
| TOTAL | 100 |

Typically, the laundry detergent powder is a solid free-flowing particulate laundry detergent composition. Typically, the laundry detergent powder is a fully formulated laundry detergent composition, not a portion thereof such as a spray-dried, extruded or agglomerate particle that only forms part of the laundry detergent composition. Typically, the solid composition comprises a plurality of chemically different particles, such as spray-dried base detergent particles and/or agglomerated base detergent particles and/or extruded base detergent particles, in combination with one or more, typically two or more, or five or more, or even ten or more particles selected from: surfactant particles, including surfactant agglomerates, surfactant extrudates, surfactant needles, surfactant noodles, surfactant flakes; phosphate particles; zeolite particles; silicate salt particles, especially sodium silicate particles; carbonate salt particles, especially sodium carbonate particles; polymer particles such as carboxylate polymer particles, cellulosic polymer particles, starch particles, polyester particles, polyamine particles, terephthalate polymer particles, polyethylene glycol particles; aesthetic particles such as coloured noodles, needles, lamellae particles and ring particles; enzyme particles such as protease granulates, amylase granulates, lipase granulates, cellulase granulates, mannanase granulates, pectate lyase granulates, xyloglucanase granulates, bleaching enzyme granulates and co-granulates of any of these enzymes, preferably these enzyme granulates comprise sodium sulphate; bleach particles, such as percarbonate particles, especially coated percarbonate particles, such as percarbonate coated with carbonate salt, sulphate salt, silicate salt, borosilicate salt, or any combination thereof, perborate particles, bleach activator particles such as tetra acetyl ethylene diamine particles and/or alkyl oxybenzene sulphonate particles, bleach catalyst particles such as transition metal catalyst particles, and/or isoquinolinium bleach catalyst particles, pre-formed peracid particles, especially coated pre-formed peracid particles; filler particles such as sulphate salt particles and chloride particles; clay particles such as montmorillonite particles and particles of clay and silicone; flocculant particles such as polyethylene oxide particles; wax particles such as wax agglomerates; silicone particles, brightener particles; dye transfer inhibition particles; dye fixative particles; perfume particles such as perfume microcapsules and starch encapsulated perfume accord particles, or pro-perfume particles such as Schiff base reaction product particles; hueing dye particles; chelant particles such as chelant agglomerates; and any combination thereof.

However, due to the very low pH (acidic) requirement of the laundry detergent powder, the addition of alkaline ingredients such as carbonate particles and silicate particles during step (b) is preferably minimized or even avoided.

Suitable laundry detergent compositions comprise a detergent ingredient selected from: detersive surfactant, such as anionic detersive surfactants, non-ionic detersive surfactants, cationic detersive surfactants, zwitterionic detersive surfactants and amphoteric detersive surfactants; polymers, such as carboxylate polymers, soil release polymer, anti-redeposition polymers, cellulosic polymers and care polymers; bleach, such as sources of hydrogen peroxide, bleach activators, bleach catalysts and pre-formed peracids; photobleach, such as such as zinc and/or aluminium sulphonated phthalocyanine; enzymes, such as proteases, amylases, cellulases, lipases; zeolite builder; phosphate builder; co-builders, such as citric acid and citrate; carbonate, such as sodium carbonate and sodium bicarbonate; sulphate salt, such as sodium sulphate; silicate salt such as sodium silicate; chloride salt, such as sodium chloride; brighteners; chelants; hueing agents; dye transfer inhibitors; dye fixative agents; perfume; silicone; fabric softening agents, such as clay; flocculants, such as polyethyleneoxide; suds supressors; and any combination thereof.

### Detersive Surfactant

Suitable detersive surfactants include anionic detersive surfactants, non-ionic detersive surfactant, cationic detersive surfactants, zwitterionic detersive surfactants and amphoteric detersive surfactants. Suitable detersive surfactants may be linear or branched, substituted or un-substituted, and may be derived from petrochemical material or biomaterial.

### Anionic Detersive Surfactant

Suitable anionic detersive surfactants include sulphonate and sulphate detersive surfactants. Suitable sulphonate detersive surfactants include methyl ester sulphonates, alpha olefin sulphonates, alkyl benzene sulphonates, especially alkyl benzene sulphonates, preferably C₁₀₋₁₃ alkyl benzene sulphonate. Suitable alkyl benzene sulphonate (LAS) is obtainable, preferably obtained, by sulphonating commercially available linear alkyl benzene (LAB); suitable LAB includes low 2-phenyl LAB, other suitable LAB include high 2-phenyl LAB, such as those supplied by Sasol under the tradename Hyblene®.

Suitable sulphate detersive surfactants include alkyl sulphate, preferably C₈₋₁₈ alkyl sulphate, or predominantly C₁₂ alkyl sulphate.

A preferred sulphate detersive surfactant is alkyl alkoxylated sulphate, preferably alkyl ethoxylated sulphate, preferably a C₈₋₁₈ alkyl alkoxylated sulphate, preferably a C₈₋₁₈ alkyl ethoxylated sulphate, preferably the alkyl alkoxylated sulphate has an average degree of alkoxylation of from 0.5 to 20, preferably from 0.5 to 10, preferably the alkyl alkoxylated sulphate is a C₈₋₁₈ alkyl ethoxylated sulphate having an average degree of ethoxylation of from 0.5 to 10, preferably from 0.5 to 5, more preferably from 0.5 to 3 and most preferably from 0.5 to 1.5.

The alkyl sulphate, alkyl alkoxylated sulphate and alkyl benzene sulphonates may be linear or branched, substituted or un-substituted, and may be derived from petrochemical material or biomaterial.

Other suitable anionic detersive surfactants include alkyl ether carboxylates.

Suitable anionic detersive surfactants may be in salt form, suitable counter-ions include sodium, calcium, magnesium, amino alcohols, and any combination thereof. A preferred counter-ion is sodium.

### Non-Ionic Detersive Surfactant

Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein preferably the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; alkylpolysaccharides, preferably alkylpolyglycosides; methyl ester ethoxylates; polyhydroxy fatty acid amides; ether capped poly(oxyalkylated) alcohol surfactants; and mixtures thereof.

Suitable non-ionic detersive surfactants are alkylpolyglucoside and/or an alkyl alkoxylated alcohol.

Suitable non-ionic detersive surfactants include alkyl alkoxylated alcohols, preferably C₈₋₁₈ alkyl alkoxylated alcohol, preferably a C₈₋₁₈ alkyl ethoxylated alcohol, preferably the alkyl alkoxylated alcohol has an average degree of alkoxylation of from 1 to 50, preferably from 1 to 30, or from 1 to 20, or from 1 to 10, preferably the alkyl alkoxylated alcohol is a C₈₋₁₈ alkyl ethoxylated alcohol having an average degree of ethoxylation of from 1 to 10, preferably from 1 to 7, more preferably from 1 to 5 and most preferably from 3 to 7. The alkyl alkoxylated alcohol can be linear or branched, and substituted or un-substituted.

Suitable nonionic detersive surfactants include secondary alcohol-based detersive surfactants.

### Cationic Detersive Surfactant

Suitable cationic detersive surfactants include alkyl pyridinium compounds, alkyl quaternary ammonium compounds, alkyl quaternary phosphonium compounds, alkyl ternary sulphonium compounds, and mixtures thereof.

Preferred cationic detersive surfactants are quaternary ammonium compounds having the general formula:

(R)(R₁)(R₂)(R₃)N⁺X⁻

wherein, R is a linear or branched, substituted or unsubstituted C₆₋₁₈ alkyl or alkenyl moiety, R₁ and R₂ are independently selected from methyl or ethyl moieties, R₃ is a hydroxyl, hydroxymethyl or a hydroxyethyl moiety, X is an anion which provides charge neutrality, preferred anions include: halides, preferably chloride; sulphate; and sulphonate.

### Zwitterionic Detersive Surfactant

Suitable zwitterionic detersive surfactants include amine oxides and/or betaines.

### Polymer

Suitable polymers include carboxylate polymers, soil release polymers, anti-redeposition polymers, cellulosic polymers, care polymers and any combination thereof.

### Carboxylate Polymer

The composition may comprise a carboxylate polymer, such as a maleate/acrylate random copolymer or polyacrylate homopolymer. Suitable carboxylate polymers include: polyacrylate homopolymers having a molecular weight of from 4,000 Da to 9,000 Da; maleate/acrylate random copolymers having a molecular weight of from 50,000 Da to 100,000 Da, or from 60,000 Da to 80,000 Da.

Another suitable carboxylate polymer is a co-polymer that comprises: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

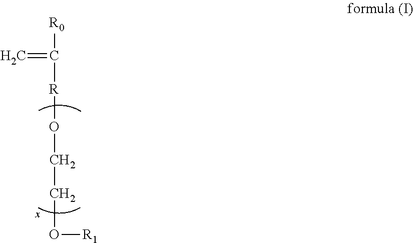

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

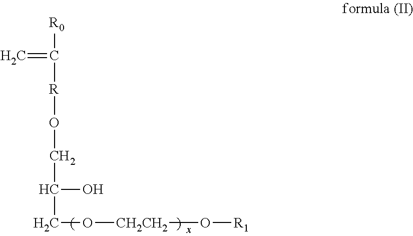

wherein in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

It may be preferred that the polymer has a weight average molecular weight of at least 50 kDa, or even at least 70 kDa.

### Soil Release Polymer

The composition may comprise a soil release polymer. A suitable soil release polymer has a structure as defined by one of the following structures (I), (II) or (III):

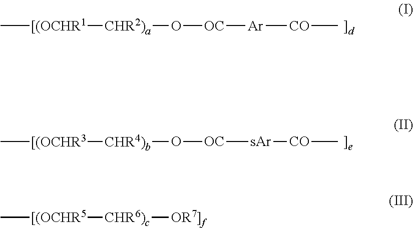

wherein:
a, b and c are from 1 to 200;
d, e and f are from 1 to 50;
Ar is a 1,4-substituted phenylene;
sAr is 1,3-substituted phenylene substituted in position 5 with SO₃Me;
Me is Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or mixtures thereof;
R¹, R², R³, R⁴, R⁵ and R⁶ are independently selected from H or C₁-C₁₈ n- or iso-alkyl; and
R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group.
Suitable soil release polymers are sold by Clariant under the TexCare® series of polymers, e.g. TexCare® SRN240 and TexCare® SRA300. Other suitable soil release polymers are sold by Solvay under the Repel-o-Tex® series of polymers, e.g. Repel-o-Tex® SF2 and Repel-o-Tex® Crystal.

### Anti-Redeposition Polymer

Suitable anti-redeposition polymers include polyethylene glycol polymers and/or polyethyleneimine polymers.

Suitable polyethylene glycol polymers include random graft co-polymers comprising: (i) hydrophilic backbone comprising polyethylene glycol; and (ii) hydrophobic side chain(s) selected from the group consisting of: C₄-C₂₅ alkyl group, polypropylene, polybutylene, vinyl ester of a saturated C₁-C₆ mono-carboxylic acid, C₁-C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide unit can be less than 0.02, or less than 0.016, the average number of graft sites per ethylene oxide unit can be in the range of from 0.010 to 0.018, or the average number of graft sites per ethylene oxide unit can be less than 0.010, or in the range of from 0.004 to 0.008.

Suitable polyethylene glycol polymers are described in WO08/007320.

A suitable polyethylene glycol polymer is Sokalan HP22.

### Cellulosic Polymer

Suitable cellulosic polymers are selected from alkyl cellulose, alkyl alkoxyalkyl cellulose, carboxyalkyl cellulose, alkyl carboxyalkyl cellulose, sulphoalkyl cellulose, more preferably selected from carboxymethyl cellulose, methyl cellulose, methyl hydroxyethyl cellulose, methyl carboxymethyl cellulose, and mixtures thereof.

Suitable carboxymethyl celluloses have a degree of carboxymethyl substitution from 0.5 to 0.9 and a molecular weight from 100,000 Da to 300,000 Da.

Suitable carboxymethyl celluloses have a degree of substitution greater than 0.65 and a degree of blockiness greater than 0.45, e.g. as described in WO09/154933.

### Care Polymers

Suitable care polymers include cellulosic polymers that are cationically modified or hydrophobically modified. Such modified cellulosic polymers can provide anti-abrasion benefits and dye lock benefits to fabric during the laundering cycle. Suitable cellulosic polymers include cationically modified hydroxyethyl cellulose.

Other suitable care polymers include dye lock polymers, for example the condensation oligomer produced by the condensation of imidazole and epichlorhydrin, preferably in ratio of 1:4:1. A suitable commercially available dye lock polymer is Polyquart® FDI (Cognis).

Other suitable care polymers include amino-silicone, which can provide fabric feel benefits and fabric shape retention benefits.

### Bleach

Suitable bleach includes sources of hydrogen peroxide, bleach activators, bleach catalysts, pre-formed peracids and any combination thereof. A particularly suitable bleach includes a combination of a source of hydrogen peroxide with a bleach activator and/or a bleach catalyst.

Source Of Hydrogen Peroxide: Suitable sources of hydrogen peroxide include sodium perborate and/or sodium percarbonate.

### Bleach Activator

Suitable bleach activators include tetra acetyl ethylene diamine and/or alkyl oxybenzene sulphonate.

### Bleach Catalyst

The composition may comprise a bleach catalyst. Suitable bleach catalysts include oxaziridinium bleach catalysts, transistion metal bleach catalysts, especially manganese and iron bleach catalysts. A suitable bleach catalyst has a structure corresponding to general formula below:

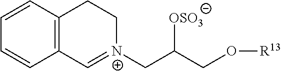

wherein R¹³ is selected from the group consisting of 2-ethylhexyl, 2-propylheptyl, 2-butyloctyl, 2-pentylnonyl, 2-hexyldecyl, n-dodecyl, n-tetradecyl, n-hexadecyl, n-octadecyl, iso-nonyl, iso-decyl, iso-tridecyl and iso-pentadecyl.

### Pre-Formed Peracid

Suitable pre-form peracids include phthalimido-peroxycaproic acid.

### Enzymes

Suitable enzymes include lipases, proteases, cellulases, amylases and any combination thereof.

### Protease

Suitable proteases include metalloproteases and/or serine proteases. Examples of suitable neutral or alkaline proteases include: subtilisins (EC 3.4.21.62); trypsin-type or chymotrypsin-type proteases; and metalloproteases. The suitable proteases include chemically or genetically modified mutants of the aforementioned suitable proteases.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark), those sold under the tradename Maxatase®, Maxacal®, Maxapem®, Preferenz P® series of proteases including Preferenz® P280, Preferenz® P281, Preferenz® P2018-C, Preferenz® P2081-WE, Preferenz® P2082-EE and Preferenz® P2083-A/J, Properase®, Purafect®, Purafect Prime®, Purafect Ox®, FN3®, FN4®, Excellase® and Purafect OXP® by DuPont, those sold under the tradename Opticlean® and Optimase® by Solvay Enzymes, those available from Henkel/Kemira, namely BLAP (sequence shown in FIG. 29 of U.S. Pat. No. 5,352,604 with the following mutations S99D+S101 R+S103A+V1041+G159S, hereinafter referred to as BLAP), BLAP R (BLAP with S3T+V41+V199M+V2051+L217D), BLAP X (BLAP with S3T+V41+V2051) and BLAP F49 (BLAP with S3T+V41+A194P+V199M+V2051+L217D)-all from Henkel/Kemira; and KAP (Bacillus alkalophilus subtilisin with mutations A230V+S256G+S259N) from Kao.

A suitable protease is described in WO11/140316 and WO11/072117.

### Amylase

Suitable amylases are derived from AA560 alpha amylase endogenous to Bacillus sp. DSM 12649, preferably having the following mutations: R118K, D183*, G184*, N195F, R320K, and/or R458K. Suitable commercially available amylases include Stainzyme®, Stainzyme® Plus, Natalase, Termamyl®, Termamyl® Ultra, Liquezyme® SZ, Duramyl®, Everest® (all Novozymes) and Spezyme® AA, Preferenz S® series of amylases, Purastar® and Purastar® Ox Am, Optisize® HT Plus (all Du Pont).

### A Suitable Amylase is Described in WO06/002643.

### Cellulase

Suitable cellulases include those of bacterial or fungal origin. Chemically modified or protein engineered mutants are also suitable. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, Carezyme®, and Carezyme® Premium, Celluclean® and Whitezyme® (Novozymes A/S), Revitalenz® series of enzymes (Du Pont), and Biotouch® series of enzymes (AB Enzymes). Suitable commercially available cellulases include Carezyme® Premium, Celluclean® Classic. Suitable cellulases are described in WO07/144857 and WO10/056652.

### Lipase

Suitable lipases include those of bacterial, fungal or synthetic origin, and variants thereof. Chemically modified or protein engineered mutants are also suitable. Examples of suitable lipases include lipases from Humicola (synonym Thermomyces), e.g., from H. lanuginosa (T. lanuginosus).

The lipase may be a “first cycle lipase”, e.g. such as those described in WO06/090335 and WO13/116261. In one aspect, the lipase is a first-wash lipase, preferably a variant of the wild-type lipase from Thermomyces lanuginosus comprising T231R and/or N233R mutations. Preferred lipases include those sold under the tradenames Lipex®, Lipolex® and Lipoclean® by Novozymes, Bagsvaerd, Denmark.

Other suitable lipases include: Liprl 139, e.g. as described in WO2013/171241; and TfuLip2, e.g. as described in WO2011/084412 and WO2013/033318.

### Other Enzymes

Other suitable enzymes are bleaching enzymes, such as peroxidases/oxidases, which include those of plant, bacterial or fungal origin and variants thereof. Commercially available peroxidases include Guardzyme® (Novozymes A/S). Other suitable enzymes include choline oxidases and perhydrolases such as those used in Gentle Power Bleach™.

Other suitable enzymes include pectate lyases sold under the tradenames X-Pect®, Pectaway® (from Novozymes A/S, Bagsvaerd, Denmark) and PrimaGreen® (DuPont) and mannanases sold under the tradenames Mannaway® (Novozymes A/S, Bagsvaerd, Denmark), and Mannastar® (Du Pont).

### Zeolite Builder

The composition may comprise zeolite builder. The composition may comprise from 0 wt % to 5 wt % zeolite builder, or 3 wt % zeolite builder. The composition may even be substantially free of zeolite builder; substantially free means “no deliberately added”. Typical zeolite builders include zeolite A, zeolite P and zeolite MAP.

### Phosphate Builder

The composition may comprise phosphate builder. The composition may comprise from 0 wt % to 5 wt % phosphate builder, or to 3 wt %, phosphate builder. The composition may even be substantially free of phosphate builder; substantially free means “no deliberately added”. A typical phosphate builder is sodium tri-polyphosphate.

### Carbonate Salt

The composition may comprise carbonate salt. The composition may comprise from 0 wt % to 5 wt % carbonate salt. The composition may even be substantially free of carbonate salt; substantially free means “no deliberately added”. Suitable carbonate salts include sodium carbonate and sodium bicarbonate.

### Silicate Salt

The composition may comprise silicate salt. The composition may comprise from 0 wt % to 5 wt % silicate salt. A preferred silicate salt is sodium silicate, especially preferred are sodium silicates having a Na₂O:SiO₂ ratio of from 1.0 to 2.8, preferably from 1.6 to 2.0.

### Sulphate Salt

A suitable sulphate salt is sodium sulphate.

### Brightener

Suitable fluorescent brighteners include: di-styryl biphenyl compounds, e.g. Tinopal® CBS-X, di-amino stilbene di-sulfonic acid compounds, e.g. Tinopal® DMS pure Xtra and Blankophor® HRH, and Pyrazoline compounds, e.g. Blankophor® SN, and coumarin compounds, e.g. Tinopal® SWN.

Preferred brighteners are: sodium 2 (4-styryl-3-sulfophenyl)-2H-napthol[1,2-d]triazole, disodium 4,4′-bis{[(4-anilino-6-(N methyl-N-2 hydroxyethyl)amino 1,3,5-triazin-2-yl)]amino}stilbene-2-2′ disulfonate, disodium 4,4′-bis {[(4-anilino-6-morpholino-1,3,5-triazin-2-yl)]amino}stilbene-2-2′ disulfonate, and disodium 4,4′-bis(2-sulfostyryl)biphenyl. A suitable fluorescent brightener is C.I. Fluorescent Brightener 260, which may be used in its beta or alpha crystalline forms, or a mixture of these forms.

### Chelant

The composition may also comprise a chelant selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid) and hydroxyethane di(methylene phosphonic acid). A preferred chelant is ethylene diamine-N′N′-disuccinic acid (EDDS) and/or hydroxyethane diphosphonic acid (HEDP). The composition preferably comprises ethylene diamine-N′N′-disuccinic acid or salt thereof. Preferably the ethylene diamine-N′N′-disuccinic acid is in S,S enantiomeric form. Preferably the composition comprises 4,5-dihydroxy-m-benzenedisulfonic acid disodium salt. Preferred chelants may also function as calcium carbonate crystal growth inhibitors such as: 1-hydroxyethanediphosphonic acid (HEDP) and salt thereof; N,N-dicarboxymethyl-2-aminopentane-1,5-dioic acid and salt thereof; 2-phosphonobutane-1,2,4-tricarboxylic acid and salt thereof; and combination thereof.

### Hueing Agent

Suitable hueing agents include small molecule dyes, typically falling into the Colour Index (C.I.) classifications of Acid, Direct, Basic, Reactive (including hydrolysed forms thereof) or Solvent or Disperse dyes, for example classified as Blue, Violet, Red, Green or Black, and provide the desired shade either alone or in combination. Preferred such hueing agents include Acid Violet 50, Direct Violet 9, 66 and 99, Solvent Violet 13 and any combination thereof. Many hueing agents are known and described in the art which may be suitable for the present invention, such as hueing agents described in WO2014/089386.

Suitable hueing agents include phthalocyanine and azo dye conjugates, such as described in WO2009/069077.

Suitable hueing agents may be alkoxylated. Such alkoxylated compounds may be produced by organic synthesis that may produce a mixture of molecules having different degrees of alkoxylation. Such mixtures may be used directly to provide the hueing agent, or may undergo a purification step to increase the proportion of the target molecule. Suitable hueing agents include alkoxylated bis-azo dyes, such as described in WO2012/054835, and/or alkoxylated thiophene azo dyes, such as described in WO2008/087497 and WO2012/166768.

The hueing agent may be incorporated into the detergent composition as part of a reaction mixture which is the result of the organic synthesis for a dye molecule, with optional purification step(s). Such reaction mixtures generally comprise the dye molecule itself and in addition may comprise un-reacted starting materials and/or by-products of the organic synthesis route. Suitable hueing agents can be incorporated into hueing dye particles, such as described in WO 2009/069077.

### Dye Transfer Inhibitors

Suitable dye transfer inhibitors include polyamine N-oxide polymers, copolymers of N-vinylpyrrolidone and N-vinylimidazole, polyvinylpyrrolidone, polyvinyloxazolidone, polyvinylimidazole and mixtures thereof. Preferred are poly(vinyl pyrrolidone), poly(vinylpyridine betaine), poly(vinylpyridine N-oxide), poly(vinyl pyrrolidone-vinyl imidazole) and mixtures thereof. Suitable commercially available dye transfer inhibitors include PVP-K15 and K30 (Ashland), Sokalan® HP165, HP50, HP53, HP59, HP56K, HP56, HP66 (BASF), Chromabond® S-400, S403E and S-100 (Ashland).

### Perfume

Suitable perfumes comprise perfume materials selected from the group: (a) perfume materials having a ClogP of less than 3.0 and a boiling point of less than 250° C. (quadrant 1 perfume materials); (b) perfume materials having a ClogP of less than 3.0 and a boiling point of 250° C. or greater (quadrant 2 perfume materials); (c) perfume materials having a ClogP of 3.0 or greater and a boiling point of less than 250° C. (quadrant 3 perfume materials); (d) perfume materials having a ClogP of 3.0 or greater and a boiling point of 250° C. or greater (quadrant 4 perfume materials); and (e) mixtures thereof.

It may be preferred for the perfume to be in the form of a perfume delivery technology. Such delivery technologies further stabilize and enhance the deposition and release of perfume materials from the laundered fabric. Such perfume delivery technologies can also be used to further increase the longevity of perfume release from the laundered fabric. Suitable perfume delivery technologies include: perfume microcapsules, pro-perfumes, polymer assisted deliveries, molecule assisted deliveries, fiber assisted deliveries, amine assisted deliveries, cyclodextrin, starch encapsulated accord, zeolite and other inorganic carriers, and any mixture thereof. A suitable perfume microcapsule is described in WO2009/101593.

### Silicone

Suitable silicones include polydimethylsiloxane and amino-silicones. Suitable silicones are described in WO05075616.

### Process for Making the Solid Composition

Typically, the particles of the composition can be prepared by any suitable method. For example: spray-drying, agglomeration, extrusion and any combination thereof.

Typically, a suitable spray-drying process comprises the step of forming an aqueous slurry mixture, transferring it through at least one pump, preferably two pumps, to a pressure nozzle. Atomizing the aqueous slurry mixture into a spray-drying tower and drying the aqueous slurry mixture to form spray-dried particles. Preferably, the spray-drying tower is a counter-current spray-drying tower, although a co-current spray-drying tower may also be suitable.

Typically, the spray-dried powder is subjected to cooling, for example an air lift. Typically, the spray-drying powder is subjected to particle size classification, for example a sieve, to obtain the desired particle size distribution. Preferably, the spray-dried powder has a particle size distribution such that weight average particle size is in the range of from 300 micrometers to 500 micrometers, and less than 10 wt % of the spray-dried particles have a particle size greater than 2360 micrometers.

It may be preferred to heat the aqueous slurry mixture to elevated temperatures prior to atomization into the spray-drying tower, such as described in WO2009/158162.

It may be preferred for anionic surfactant, such as linear alkyl benzene sulphonate, to be introduced into the spray-drying process after the step of forming the aqueous slurry mixture: for example, introducing an acid precursor to the aqueous slurry mixture after the pump, such as described in WO 09/158449.

It may be preferred for a gas, such as air, to be introduced into the spray-drying process after the step of forming the aqueous slurry, such as described in WO2013/181205.

It may be preferred for any inorganic ingredients, such as sodium sulphate and sodium carbonate, if present in the aqueous slurry mixture, to be micronized to a small particle size such as described in WO2012/134969.

Typically, a suitable agglomeration process comprises the step of contacting a detersive ingredient, such as a detersive surfactant, e.g. linear alkyl benzene sulphonate (LAS) and/or alkyl alkoxylated sulphate, with an inorganic material, such as sodium carbonate and/or silica, in a mixer. The agglomeration process may also be an in-situ neutralization agglomeration process wherein an acid precursor of a detersive surfactant, such as LAS, is contacted with an alkaline material, such as carbonate and/or sodium hydroxide, in a mixer, and wherein the acid precursor of a detersive surfactant is neutralized by the alkaline material to form a detersive surfactant during the agglomeration process.

Other suitable detergent ingredients that may be agglomerated include polymers, chelants, bleach activators, silicones and any combination thereof.

The agglomeration process may be a high, medium or low shear agglomeration process, wherein a high shear, medium shear or low shear mixer is used accordingly. The agglomeration process may be a multi-step agglomeration process wherein two or more mixers are used, such as a high shear mixer in combination with a medium or low shear mixer. The agglomeration process can be a continuous process or a batch process.

It may be preferred for the agglomerates to be subjected to a drying step, for example to a fluid bed drying step. It may also be preferred for the agglomerates to be subjected to a cooling step, for example a fluid bed cooling step.

Typically, the agglomerates are subjected to particle size classification, for example a fluid bed elutriation and/or a sieve, to obtain the desired particle size distribution. Preferably, the agglomerates have a particle size distribution such that weight average particle size is in the range of from 300 micrometers to 800 micrometers, and less than l0 wt % of the agglomerates have a particle size less than 150 micrometers and less than l0 wt % of the agglomerates have a particle size greater than 1200 micrometers.

It may be preferred for fines and over-sized agglomerates to be recycled back into the agglomeration process. Typically, over-sized particles are subjected to a size reduction step, such as grinding, and recycled back into an appropriate place in the agglomeration process, such as the mixer. Typically, fines are recycled back into an appropriate place in the agglomeration process, such as the mixer.

It may be preferred for ingredients such as polymer and/or non-ionic detersive surfactant and/or perfume to be sprayed onto base detergent particles, such as spray-dried base detergent particles and/or agglomerated base detergent particles. Typically, this spray-on step is carried out in a tumbling drum mixer.

### Method of Laundering Fabric

The method of laundering fabric comprises the step of contacting the solid composition to water to form a wash liquor, and laundering fabric in said wash liquor. Typically, the wash liquor has a temperature of above 0° C. to 90° C., or to 60° C., or to 40° C., or to 30° C., or to 20° C. The fabric may be contacted to the water prior to, or after, or simultaneous with, contacting the solid composition with water. Typically, the wash liquor is formed by contacting the laundry detergent to water in such an amount so that the concentration of laundry detergent composition in the wash liquor is from 0.2 g/l to 20 g/l, or from 0.5 g/l to 10 g/l, or to 5.0 g/l. The method of laundering fabric can be carried out in a front-loading automatic washing machine, top loading automatic washing machines, including high efficiency automatic washing machines, or suitable hand-wash vessels. Typically, the wash liquor comprises 90 litres or less, or 60 litres or less, or 15 litres or less, or 10 litres or less of water. Typically, 200 g or less, or 150 g or less, or 100 g or less, or 50 g or less of laundry detergent composition is contacted to water to form the wash liquor.

### Method for Measuring pH

The pH of the sample is typically measured by dissolving the sample in deionized water at 20° C. to a concentration of 1 g/l. A calibrated pH probe can then be used to determine the pH of the solution. Suitable pH probes include Jenway 3510 pH Meter.

Method for Measuring Equilibrium Relative Humidity (eRH)

Equilibrium relative humidity (eRH) measures the vapour pressure generated by the moisture present in a sample. It can be expressed as:

eRH=100×Aw

wherein Aw is water activity:

Aw=p/ps, where:

p is the partial pressure of water vapour at the surface of the composition; and

ps is the saturation pressure (the partial pressure of water vapour above pure water at the composition temperature).

Water activity reflects the active part of moisture content or the part which, under the established conditions (20° C.), can be exchanged between a composition and its environment. For the purpose of the present invention invention all the measurements are taken at atmospheric pressure unless stated otherwise.

The eRH is typically measured at atmospheric pressure and 20° C. temperature by collecting a sample (e.g. 15 g) in a petri-dish (e.g. 3.0 cm diameter). An eRH probe (e.g. Rotronic) is placed on the top of the petri-dish such that a headspace of air is between the sample and the eRH probe. The sample is allowed to equilibrate, e.g. the eRH readings on the eRH probe are stable. This stable reading is the eRH.

### EXAMPLES

### Example 1

A comparison was made between a particulate laundry detergent composition which is latterly exposed to additional environmental humidity to simulate conditions which may be encountered between mixing and packing the detergent.

Prior to mixing, citric acid was passed through a 425 micron sieve to remove particles larger than 425 micron. Table 1 details the particle size distribution of the citric acid after screening.

TABLE 1

| Sieve Size | Cumulative weight citric |
|---|---|
| (micron) | acid¹ through (%) |
| 600 | 99.84 |
| 425 | 97.10 |
| 300 | 47.83 |
| 212 | 18.40 |
| 150 | 1.09 |
| 0 | 0 |

¹Citric Acid Fine Granular 51N, sourced from Citrique Belge, B-3300 Tienen Belgium

From this, by means of statistical analysis of a normal distribution, the citric acid sample was determined to have a D₅₀ particle size of 293 micron and a D₉₉ of 516 micron.

Particulate laundry detergent powder according table 2, parts by weight %, including the pre-screened citric acid, was prepared by dry mixing, in a batch mixer, with non-ionic surfactant sprayed and dispersed onto the powder.

TABLE 2

| | |
|---|---|
| Citric acid (screened < 425micron) | 60.0 wt % |
| Tetrasodium salt of hydroxyethylene | 0.64 wt % |
| diphosphonic acid | |
| Sodium Aluminosilicate (zeolite A) | 5.0 wt % |
| Sodium Sulphate | 26.26 wt % |
| Starch encapsulated perfume | 0.14 wt % |
| C₁₂-C₁₄ alkyl sulphate agglomerate | 6.44 wt % |
| (detergent base) | |
| Perfume | 0.32 wt % |
| Ethoxylated C₁₄-C₁₅ alcohol having an | 1.2 wt % |
| average degree of ethoxylation of 7 | |
| (AE7) | |

The laundry detergent powder, upon dilution in deionized water at 20° C. to a concentration of 1g/l has a pH of 3.0.

Powder Flowability after Humid Storage

The flowability of a powder can be described by measuring the dynamic flow rate (DFR). Powder is allowed to gravity flow through a cylindrical glass tube of diameter 35 mm and length 600 mm Powder is loaded into the tube via a funnel until the tube volume reaches a point 500 mm above the tube outlet. Lasers are placed 150 mm and 400 mm above the tube outlet, and these are used to record time. Upon commencement of powder flow, time starts when the upper most powder passes the first laser at 400 mm and finishes when passing the second laser at 150 mm. The time is recorded. The dynamic flow rate is calculated using the equation

DFR(mL/s)=V/t

where V is the volume of the cylinder between the two lasers, and t, is the time taken for the powder to flow.

A particulate laundry composition was prepared according to table 2 and sampled to the required test volumes. One sample was then placed in an environmental humidity chamber set at 25° C., 60% RH for 48 hours. One sample remained in ambient conditions in a sealed container. Before measuring DFR, the temperature and equilibrium relative humidity of the samples was measured and recorded.

TABLE 3

| | | Equilibrium | Dynamic | Relative |
|---|---|---|---|---|
| | Temper- | Relative | Flow Rate | Standard |
| | ature | Humidity | (DFR), | Deviation |
| Sample | (° C.) | (eRH %) | mL/s | (%) |
| 1 | 23.68 | 21.52 | 123.8 | 1.92 |
| 2 | 23.23 | 58.92 | Did not flow | |

As can be seen from table 3, the sample which had been exposed to 48 hours at 25° C., 60% RH had become cohesive and did not flow.

### Example 2 (Illustrative Example)

A laundry detergent base particle is obtained by agglomerating C₁₂-C₁₄ alkyl sulphate with sodium sulphate.

The laundry detergent base particle has the following composition:
C₁₂-C₁₄ alkyl sulphate 90 wt %
sodium sulphate 10 wt %

Citric acid particles are prepared by passing citric acid through a sieve to remove particles of 600 600 micron or greater, and size classified (if required) to remove particles less than 100 micron. The citric acid has a D₅₀ of 293 micron.

1.5 kg of citric acid particles are then mixed with 1.5 kg of the laundry detergent base particle at an eRH of 20%.

The laundry detergent powder has the following composition:
C₁₂-C₁₄ alkyl sulphate 45 wt %
solution sulphate 5 wt %
citric acid 50 wt %

The laundry detergent powder, upon dilution in deionized water at 20° C. to a concentration of 1 g/l has a pH of 2.9.

The laundry detergent powder was transferred to a storage vessel (bag) at an eRH of 20%.

The laundry detergent powder was then packaged into 50 g sachets (gravity fed through a funnel into the sachet ( ) and heat sealed) at an eRH of 20% to form a packaged laundry detergent powder.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A process for making a packaged laundry detergent powder, wherein the process comprises the steps of:
(a) obtaining a laundry detergent base powder comprising detersive surfactant;
(b) contacting citric acid particles to a detergent base powder in a mixer to form a laundry detergent powder,
wherein the citric acid particles have a weight average particle size of from about 100 μm to less than about 450 μm, and wherein at least about 99 wt % of the citric acid particles have a particle size of from about 100 μm to less than about 650 μm,
wherein the laundry detergent powder, upon dilution in deionized water at about 20° C. to a concentration of about 1 g/l has a pH in the range of from about 2.0 to about 4.0, and
wherein the laundry detergent powder comprises:
(i) from about 1 wt % to about 60 wt % detersive surfactant; and
(ii) from about 40 wt % to about 80 wt % citric acid;
(c) transferring the laundry detergent powder from the mixer to a storage vessel; and
(d) transferring the laundry detergent powder from the storage vessel to a package to form a packaged laundry detergent powder,
wherein steps (b), (c) and (d) are carried out at an equilibrium relative humidity (eRH) of about 45% or less.

2. A process according to claim 1, wherein in step (b) the citric acid particles have a particle size distribution such that at least about 99 wt % of the citric acid particles have a particle size of from about 100 μm to less than about 550 μm.

3. A process according to claim 1, wherein the laundry detergent powder formed in step (b) comprises from about 50 wt % to about 60 wt % citric acid.

4. A process according to claim 1, wherein the laundry detergent base powder comprises anionic detersive surfactant.

5. A process according to claim 4, wherein the anionic detersive surfactant is C₁₁₋₁₃ linear alkyl benzene sulphonate.

6. A process according to claim 1, wherein the laundry detergent powder formed in step (b) comprises:
(i) from about 0.0001 wt % to about 2.5 wt % perfume;
(ii) from about 0.0 wt % to about 6.0 wt % polymer;
(iii) from about 0.0001 wt % to about 3.0 wt % hueing agent; and
(iv) from about 1 wt % to about 58 wt % filler.

7. A process according to claim 1, wherein the laundry detergent powder formed in step (b), upon dilution in deionized water at about 20° C. to a concentration of about 1 g/l has a pH in the range of from about 2.5 to below about 3.0.

8. A process according to claim 1, wherein steps (b), (c) and (d) are carried out at an equilibrium relative humidity (eRH) of 30% or less.

9. A process according to claim 1, wherein steps (b), (c) and (d) are carried out at an equilibrium relative humidity (eRH) of about 25% or less.
